(19) United States
(12) Patent Application Publication
(10) Pub. No.: US 2025/0073635 A1
(43) Pub. Date: Mar. 6, 2025

(54) ENERGY EFFICIENT POST-COMBUSTION CO2 CAPTURING PROCESS USING IONIC LIQUID ABSORBENT

(71) Applicant: Chevron U.S.A. Inc., San Ramon, CA (US)

(72) Inventors: Dominic BURNS, Carryduff (GB); Hye-Kyung C. TIMKEN, San Ramon, CA (US); John HOLBREY, Belfast (GB); Huping LUO, San Ramon, CA (US); Evan HATAKEYAMA, San Ramon, CA (US)

(73) Assignee: Chevron U.S.A. Inc., San Ramon, CA (US)

(21) Appl. No.: 18/816,370

(22) Filed: Aug. 27, 2024

Related U.S. Application Data
(60) Provisional application No. 63/535,190, filed on Aug. 29, 2023.

(51) Int. Cl. B01D 53/14; B01D 53/62; B01D 53/78; B01D 53/96

(52) U.S. Cl. CPC B01D 53/1493; B01D 53/1425; B01D 53/1475; B01D 53/1481; B01D 53/62; B01D 53/78; B01D 53/96; B01D 2252/30; B01D 2257/302; B01D 2257/308; B01D 2257/404; B01D 2257/504; B01D 2258/0283

(57) ABSTRACT

In one embodiment is provided an energy-efficient post-combustion CO₂ capturing process utilizing protic ionic liquids made of an organic superbase and a weak acid in the presence of moisture. The concept is demonstrated in one embodiment with the ionic liquid, 1,8-diazabiciclo(5.4.0)undec-7-enium imidazolate, [DBUH][Im].

### RELATED APPLICATION

This application claims priority to and benefit of U.S. Provisional Application No. 63/535,190 filed Aug. 29, 2023, the contents of which are hereby incorporated by reference herein their entirety.

### BACKGROUND

One major source of carbon dioxide (CO₂) emission in the atmosphere is flue gas exhaust from large industrial conversion processes such as refinery heater and boilers, steam generators, gas turbines, power plants etc., as well as large energy consuming industries such as cement, iron and steel production, chemicals production and oil refining. It is desirable to develop a cost and energy efficient process for separating CO₂ from the flue gases for the purpose of CO₂ capture for utilization and/or sequestration (CCUS). This approach is known as “post-combustion” CO₂ capture.

Before CO₂ can be sequestered from a large industrial source, it must be captured in a relatively pure form. CO₂ is routinely separated and captured as a by-product of industrial processes such as synthetic ammonia production, hydrogen (H₂) production or limestone calcination. Existing CO₂ capture technologies, however, are not cost-effective when considered in the context of sequestering CO₂ from large point sources. Most large point sources use air-fired combustors, a process that exhausts CO₂ diluted with nitrogen and containing moisture. For efficient carbon sequestration, the CO₂ in these exhaust gases must be separated and concentrated.

The only commercially proven methods of post-combustion CO₂ capture use aqueous amine-based absorbents, and there are many challenges associated with this type of technology such as low loading capacity and high energy consumption. Also, there are several mechanisms of amine-loss such as degradation of amine in the presence of oxygen in the flue gas, formation of a heat-stable salt from reaction with CO₂, and volatility of the amine. Due to the high loss, a continuous makeup of the aqueous amine absorbent is required.

The flue gas absorber temperature is cooled to ˜50-60° C. The regenerator typically operates ˜120° C. to desorb CO₂. The cooling for absorption and the heating for regeneration consumes significant amount of energy. In order to reach the regeneration temperature, water in the aqueous amine solvents need to be boiled and this step is particularly energy intensive.

Ionic Liquids (IL) are a class of compounds that are made up entirely of ions and are liquid at or below process temperatures. ILs are known in the art to have vanishingly low or negligible vapor pressure, and are often studied as candidates for environmentally-benign solvents, catalysts, and gas and liquid-phase separation agents. Many ILs known in the art behave as physical solvents, meaning that the loading capacity of CO₂ is linear with the equilibrium partial pressure of CO₂. These ILs are unsuitable for flue-gas applications since the partial pressure of CO₂ is from about 0.04 to about 0.15 atm and are better suited for highly-concentrated CO₂ applications such as syngas. Other ILs appear more active for CO₂ at lower partial pressures and have non-linear loading curves, for example, bmim acetate (Butyl-methylimidazolium acetate) as disclosed in U.S. Pat. No. 7,527,775. The anions of this type of ILs are able to interact favorably with CO₂ and thereby have higher loadings at low partial pressure.

Researchers have also developed task-specific IL (TSIL) and other forms of functionalized ILs that have chemical functional groups designed to interact even more strongly and/or specifically with CO₂. Although these amine-functionalized ILs are known to have a high capacity for CO₂, they are also known to be far more viscous compared to non-functionalized ILs. However, a high viscosity is undesirable on a commercial scale, because it means that pumping costs are higher, mass transfer kinetics between gas and liquid are lower (resulting in taller columns and more packing material), and the efficiency of heat transfer is reduced (needed for eventual regeneration).

Issues with viscosity, efficiency, and effectiveness still persist. Accordingly, there is a continued need for improved systems and process for removing CO₂ from flue gases that can be carried out in a simple, cost effective and energy-effective manner.

### SUMMARY

Provided is a process for CO₂ capture from flue gas in the presence of moisture. The CO₂ reacts with water rapidly and forms H₂CO₃ carbonic acid. In the presence of base (proton accepter), carbonic acid forms bicarbonate anion with the ionic liquid. The carbonic acid is absorbed in the present ionic liquid (IL) as bicarbonate anion, HCO₃⁻. The bicarbonate binds to the present IL very strongly up to 90° C., after that the CO₂ uptake capacity gradually lowers. The present CO₂ capture and recovery process was developed where CO₂ absorption occurs in the range of 80° C. to 95° C. and desorption around 160° C., e.g., from 140° C. to 200° C.

In one embodiment is provided an energy-efficient post-combustion CO₂ capturing process in the presence of moisture utilizing protic ionic liquids made of an organic superbase and a weak acid. The concept is demonstrated in one embodiment with the ionic liquid, 1,8-diazabiclclo(5.4.0)undec-7-enium imidazolate, [DBUH][Im], shown in FIG. 1.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 provides a schematic of the chemical makeup of the ionic liquid [DBUH][Im].

FIG. 2 depicts a synthesis scheme for [DBUH][Im].

FIG. 3 is a schematic of a one embodiment of the present process for removing CO₂ from a flue gas.

FIG. 4 graphically depicts a CO₂ absorption isotherm of dry and water containing [DBUH][Im] ionic liquids.

FIG. 5 graphically depicts the net CO₂ recovery capacity per an absorption and desorption cycle.

FIG. 6. graphically depicts CO₂ uptake vs time with [DBUH][Im] and 10 wt % water with various concentrations and flow rates of gas.

FIG. 7 graphically depicts CO₂ captured by the formation of bicarbonate in the liquid mixture.

FIG. 8. is a composition of the mixture after multiple absorption-desorption cycles in the presence of water, ending on a desorption cycle.

FIG. 9 is a composition upon repeated absorption-desorption cycles.

FIG. 10 graphically depicts results showing that water containing [DBUH][Im] ionic liquid is stable and CO₂ uptake capacity is maintained.

### DETAILED DESCRIPTION

The present invention is directed to a process for separating CO₂ from a flue gas stream. In one embodiment, the process involves (a) contacting a flue gas stream containing water vapor and CO₂ with an ionic absorbent under absorption conditions to absorb at least a portion of the CO₂ from the flue gas stream and form a CO₂-absorbent complex; wherein the ionic absorbent is a protic ionic liquid of a super base and a weak acid; and (b) recovering a gaseous product having a reduced CO₂ content. In one embodiment, absorption occurs at a temperature in the range of from 80° C. to 95° C., and is followed by desorption at a temperature in the range of from 140° C. to 200° C.

### The Flue Gas Stream

The flue gas stream for use in the process of the present processes may be any flue gas stream that is generated from a combustion apparatus such as a refinery plant, industrial power plant, etc. In one embodiment, the flue gas stream is from a stack that removes flue gas discharged from an industrial facility to the outside. Representative examples of such flue gas streams includes a gas turbine flue gas, a furnace flue gas, a hot oil furnace flue gas, a steam generator flue gas, a preheater flue gas, a reformer flue gas, steam methane reformer flue gas, FCC (fluid catalytic cracker) regenerator flue gas, CFB (circulating fluid bed boiler) and the like. The flue gas stream contains at least some amount of water vapor and CO₂. In one embodiment, the flue gas stream contains fully saturated water. In another embodiment, the flue gas stream contains about 50% up to 100% humidity. In general, the amount of CO₂ present in the flue gas will depend on its source. For example, for a flue gas from a combined cycle gas turbine, the flue gas stream contains about 3.5 mol % CO₂. Alternatively, for a flue gas from steel production or cement kilns, the flue gas stream contains about 30 mol % CO₂. Accordingly, in one embodiment, the flue gas stream contains from about 3.5 mol % to about 30 mol % CO₂. In another embodiment, the flue gas stream contains from about 4 mol % to about 15 mol % CO₂. In another embodiment, the flue gas stream contains from about 10 mol % to about 15 mol % CO₂. Besides CO₂, the flue gas stream can also contain oxygen compounds, sulfur compounds and nitrogen compounds.

In general, the flue gas stream is typically a hot flue gas stream, i.e., a flue gas stream having a temperature of at least about 80° C. (175° F.). In another embodiment, the flue gas stream has a temperature ranging from about 80° C. to about 150° C. (300° F.). While the temperature of the flue gas stream can always be higher, for practical reasons this is generally not the case unless the original combustion device (e.g., heater, boiler, etc.) was poorly designed and highly in-efficient. In addition, the flue gas stream can have a lower temperature in the case where a configuration that includes pre-cooling of the flue gas or input from a cooled gas sources such as wet FGD (flue gas desulfurization) effluent is used.

### The Ionic Absorbent

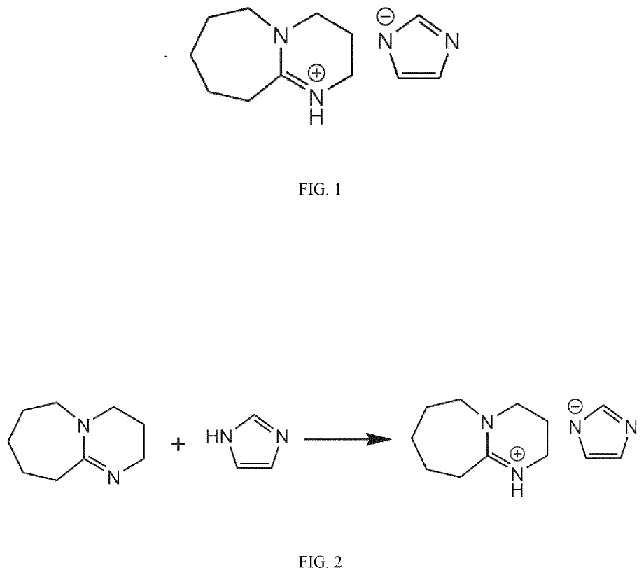

The ionic absorbent (IL) of the present processes comprises a protic ionic liquid made from an organic superbase and a weak acid. In one embodiment such an IL is [DBUH][Im], shown in FIG. 1. A process of preparing such an IL is depicted in FIG. 2.

An organic superbase is a charge-neutral chemical compound having a very high basicity or a high affinity for protons. Common superbases feature amidine, guanidine, and phosphazene functional groups. Organic superbases have higher basicity than the reference compound 1,8-Bis(dimethylamino)naphthalene, also known as a proton sponge. Organic superbases commonly contain basic nitrogen containing species, where nitrogen acts as a proton acceptor.

A good reference of known organic superbases was published by T. R. Puleo, S. J. Sujansky, S. E. Wright and J. S. Bandar, Chem. Eur. J. 2021, 27, 4216-4229. DOI: 10.1002/chem.202003580.

A few examples of suitable organic superbases include 1,8-Diazabicyclo(5.4.0)undec-7-ene (DBU), 1,5-Diazabicyclo(4.3.0)non-5-ene (DBN), 1,1,3,3-Tetramethylguanidine (TMG), Triazabicyclodecene (TBD), and 7-Methyl-1,5,7-triazabicyclo(4.4.0)dec-5-ene (MTBD).

The structures of these organic superbases are shown below.

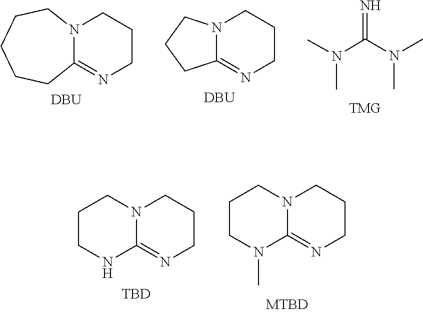

Protic ionic liquid is a subset of ionic liquid prepared by a stoichiometric neutralization reaction of a Bronsted acid with a Bronsted base to yield a liquid salt product. A good reference for Protic ionic liquid was published by T. L Greaves and C. J. Drummond, Chem. Rev. 2008, 108, 206-237. DOI: 10.1021/cr068040u.

The present process utilizes a protic ionic liquid comprised of an organic superbase and an organic molecule with a weakly acidic proton to capture CO₂. Reaction of organic molecules with an acidic proton, such as imidazole, and an organic superbase, such as DBU, forms a protic ionic liquid, [DBUH]⁺[Im]⁻ also described as [DBUH][Im]. The reaction is an acid-base pairing reaction to form a salt, an ionic liquid. This is shown in FIG. 2.

A few examples of organic molecules with weakly acidic protons includes Imidazole (Im), 1,2,3 and 1,2,4-Triazoles (Triz), Pyrrole (Pyr), Pyrazole (Pyrz), and Indole (In). The structures of these organic molecules with an acidic proton are shown below.

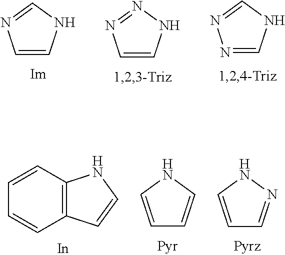

### CO₂ Capturing Process

The present process removes CO₂ from a flue gas stream containing water vapor and CO₂. The flue gas stream is contacted with an ionic absorbent comprising the present ionic liquid at a temperature ranging from 80° C. to 95° C. The CO₂ bonds strongly to the ionic liquid absorbent in the temperature range of 80° C. to 95° C. A CO₂ lean gas can then be recovered or released to the atmosphere.

The ionic liquid absorbent can be regenerated by heating at a temperature of at least 120° C., for example, at a temperature in the range of from 120° C. to 200° C., preferably 140° C. to 200° C. . . . The CO₂ gas can then be recovered, and the ionic liquid, now regenerated, can be recycled and used again.

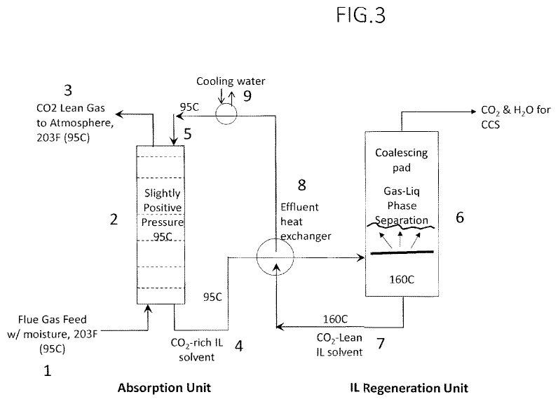

Referring to FIG. 3, one embodiment of an integrated process is depicted. A flue gas 1 with moisture is sent to an absorption unit 2. The absorption unit is maintained at a temperature of 95° C. A CO₂ lean gas is recovered at 3, and a CO₂ rich IL 4 is recovered out the bottom of the absorption unit 2. IL fluid 5 (CO₂ lean IL, which make-up can be fresh IL and Regenerated IL) is used to maintain the temperature of the absorption unit at 95° C. and to ensure the absorption occurs at a temperature in the range of from 80° C. to 95° C.

The CO₂ rich IL 4 can then be passed to an IL regeneration unit 6. The regeneration unit 6 is maintained at 160° C. A CO₂ lean IL 7 is recovered out of the bottom of the IL regeneration unit 6 and can be recycled to the absorption unit. The 160° C. CO₂ lean IL stream recycled is cooled to 95° C. prior to entering the absorption unit. The cooling can be achieved by an effluent heat exchanger 8, and a supplemental heat exchanger 9.

An important aspect of the present process is that the IL is a protic ionic liquid from a superbase and weak acid as previously described. It is the use of this type of IL absorbent which permits the moderately strong absorption of the CO₂ in the temperature range of 80° C. to 95° C. Also discovered was that desorption can then be achieved at a higher temperature of at least 120° C. In one embodiment the temperature range for desorption is 120° C. to 200°, C, preferentially 140° C. to 200° C. Without the use of the present IL, the ability to favorably absorb and then desorb efficiently and effectively would not be possible.

The present process has been found to have several advantages. One advantage is that the process can feed the flue gas containing CO₂ to the adsorption unit without cooling to a low temperature. This avoids the economic cost of having to cool the flue gas.

The ionic liquid in the present process can also capture CO₂ in the flue gas in the presence of moisture/water, even though moisture can affect the CO₂ capturing ability of the ionic liquid. The ionic liquid absorbent does not contain any water. The only water in the process is coming from the moisture in the flue gas and the ionic liquid absorbs the moisture. One notable, surprising discovery is that the present wet ionic liquid still has CO₂ capturing ability at the absorbing temperature. However, the optimum process condition may need to be shifted in order to accommodate water in the flue gas.

The amount of water in the process is a minor amount. Unlike the aqueous amine technology, there is no water to boil off. This makes heating for regeneration and recovery of CO₂ far more energy efficient.

Since the ionic liquid is not volatile, there is negligible loss of ionic liquid absorbent during the regeneration step.

Operation at high temperatures also lowers the viscosity of the present ionic liquid significantly. This allows for more efficient contact of gas and ionic liquid with lower energy consumption. The viscosity of the water-containing [DBUH][Im] ionic liquid, for example, is in the range of 1.8 to 10 cSt. As the ionic liquid absorbs CO₂, the viscosity increases. It is desirable to have a viscosity of the ionic liquid to be maintained less than 30 cSt after absorption of CO₂ so that the ionic liquid can be pumped easily using conventional pumps.

Reference will now be made in detail to exemplary aspects of the present disclosure that are illustrated in the accompanying drawings. Wherever possible, the same reference numbers will be used throughout the drawings to refer to the same or like parts.

The following examples are provided to illustrate certain embodiments, but are not meant to be limiting.

### Example 1: Synthesis of [DBUH][Im]

Imidazole (68.4178 g, 1.005 mol) was added to a 500 mL round bottom flask and cooled in an ice bath. An equimolar amount of 1,8-Diazabicyclo(5.4.0)undec-7-ene (150 mL, 152.7 g, 1.003 mol) was then added dropwise with vigorous stirring. The flask was heated to 50° C. under high vacuum overnight to remove traces of water, resulting in a quantitative yield of clear yellow [DBUH][Im]. The synthesis scheme is shown in FIG. 2.

### Example 2

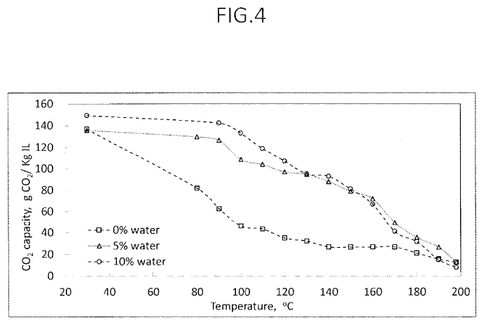

CO₂ absorption isotherm by ionic liquid was measured by bubbling CO₂ gas into the ionic liquid at atmospheric pressure for about 10 minutes, which is long enough for the system to reach a steady state. The absorption temperature was varied widely from 30° C. to 195° C. The CO₂ uptake was measured by weight gain of the ionic liquid. To examine the effects of moisture present in the flue gas, 5 wt % and 10 wt % of water each was added to the ionic liquid and the CO₂ absorption isotherms were measured. 7.5 wt % water corresponds to equimolar ratio of [DBUH][Im] IL and H₂O. The plot of CO₂ absorption isotherm at various temperature is shown in FIG. 4.

Very different absorption profiles were found for dry [DBUH][Im] ionic liquid and water-containing [DBUH][Im] as shown in FIG. 4, which was surprising. This clearly indicated that the CO₂ absorption mechanism is different for dry [DBUH][Im] ionic liquid compared to water-containing [DBUH][Im].

While not wishing to be bound by a theory, the results suggest that the dry [DBUH][Im] ionic liquid captures CO₂ by binding CO₂ directly to the imidazolium N anion which is basic in nature. When water is present in the ionic liquid, then CO₂ appears to form carbonic acid, H₂CO₃. Then, the proton dissociated from the carbonic acid may be bound to the imidazolium N anion and the bicarbonate anion, [HCO₃]⁻, is balancing the charge with the [DBUH] cation. These ion pairs are strongly bound and CO₂ does not desorb from the water-containing [DBUH][Im] until the temperature reaches about 90-100° C. This explains the reason isotherms look so different for CO₂ absorption when moisture is present.

### Example 3

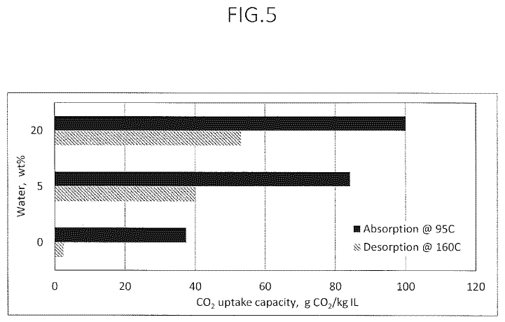

The isotherm plot shown in FIG. 4 and Example 2 indicate that bicarbonate is very strongly bound to the ionic liquid between temperatures of 30-90° C. To facilitate efficient absorption-desorption cycle of CO₂, higher operating temperatures were selected. Here the samples were heated to 95° C. prior to CO₂ bubbling which shows a noticeable drop in capacity from low temperature absorption and then heating to 95° C. Desorption was then performed by heating the samples to 160° C. with constant agitation and no gas flow at atmospheric pressure. The desorption temperature of 160° C. was chosen where the ionic liquid showed good thermal stability. The net CO₂ uptake capacity for single absorption and desorption cycle was determined for dry [DBUH][Im] ionic liquid, and 5 wt % and 20 wt % of water added ionic liquids by using the weights. The results are plotted in FIG. 5.

The data above shows that dry [DBUH][Im] ionic liquid can remove 35 g of CO₂/kg of ionic liquid per absorption and desorption cycle. Water-containing [DBUH][Im] ionic liquid can remove 44-47 g of CO₂ per kg of ionic liquid per absorption and desorption cycle.

### Example 4: Energy Efficient Post-Combustion CO₂ Capture Process

Based on the isotherm and net CO₂ recovery capacity data, an integrated continuous process was developed to remove CO₂ from the flue gas. One embodiment of the process is depicted in FIG. 3.

### Example 5: CO₂ Uptake of [DBUH][Im] Ionic Liquid for Dilute CO₂ Stream

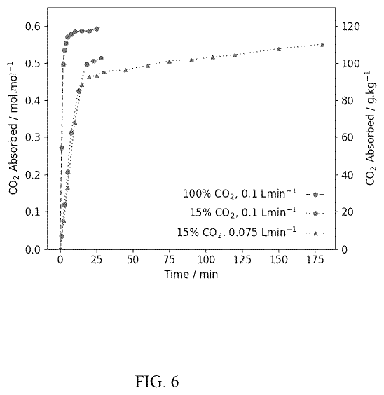

A dilute CO₂ gas made of 85 vol % N₂ and 15 vol % CO₂ was prepared to simulate the concentration of CO₂ typically observed in flue gas. CO₂ uptake was measured for 10 wt % water containing [DBUH][Im] ionic liquid. The results showed that the presence of N₂ does not interfere with the CO₂ absorption mechanism and the total uptake capacity is similar to 100% CO₂ flow. It was observed that the rate of absorption changed along with the isotherm shape. With 15% CO₂ containing gas, about ˜100 g of CO₂ was absorbed quickly (in about 10 min), only slightly slower than the 100% CO₂ flow. Then, the further uptake of CO₂ (about the last 10 g, or from 100 g to 110 g of CO₂ uptake) was substantially slower due to competition between N₂ and CO₂ and limited availability of remaining absorption sites. The results are shown graphically in FIG. 6.

This result suggests that a uniformly absorbed, stable complex of IL, CO₂ and water is being made even in the co-presence of a large amount of inert N₂ gas and moisture, which is the typical situation with flue gas. The continuous process proposed in Example 4 (FIG. 3) is quite feasible.

### Example 6: Novel Ionic Composition after CO₂ and Moisture Absorption

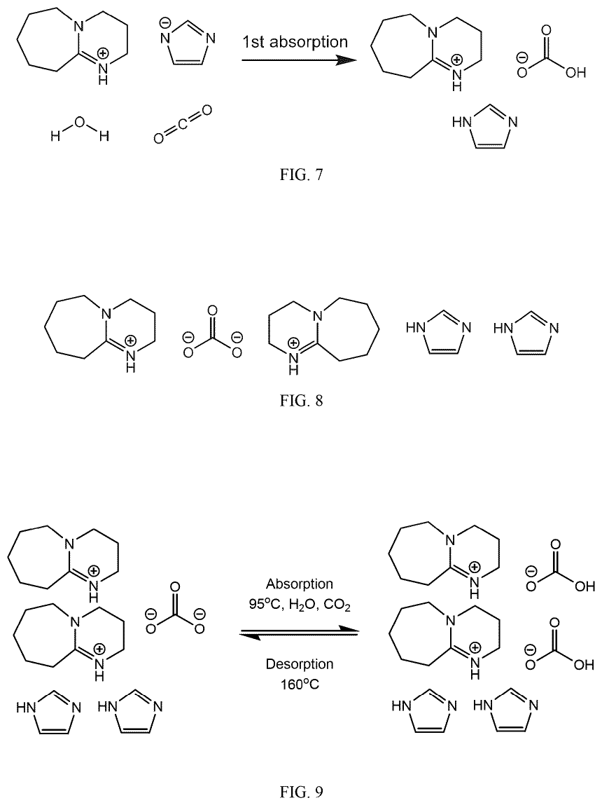

It is believed that heretofore no one has used water-containing [DBUH][Im] ionic liquid to capture CO₂. In the presence of moisture and base (proton accepter), CO₂ forms bicarbonate anion with the ionic liquid. The CO₂ uptake at the ambient temperature corresponds to 1:1:1 molar ratio to the ionic liquid and to water. See FIG. 7. The resulting compound is a 1:1:1 complex of [DBUH] cation, neutral imidazole molecule, and bicarbonate anion. This was confirmed by FT-IR and NMR spectroscopy. This is a new homogeneous composition of ionic liquid and neutral imidazole that has not been previously made.

The CO₂ uptake shows little change between 30° C. and 90° C. temperature. Through the use of FT-IR and NMR spectroscopy, the formation of bicarbonate, [HCO₃]⁻ and ionic liquid complex was observed. The mechanism of formation is unclear if this happens though a carbamate or hydroxyl pathway or both pathways simultaneously. Regardless, equimolar amounts of [DBUH][Im], H₂O and CO₂ react to form [DBUH][HCO₃] and a neutral imidazole molecule.

Until the [DUBH][Im] ionic liquid reaches the full CO₂ uptake capacity, i.e., to reach 1:1 molar ratio of ionic liquid ([DBUH]⁺[HCO₃]⁻) and neutral imidazole molecule complex, the composition of IL will have varying compositions of [DBUH][HCO₃]ₓ[Im]₁₋ₓ and x mole of neutral imidazole molecule, where x varies from 0 to 1. An x of 0.1 corresponds to 0.1 mole fraction of imidazolium anion replaced with bicarbonate anions, in other words, the mol·mol−1 uptake of CO₂ per ionic liquid. For the present system a maximum of x=0.7 (FIG. 2) has been observed at 30° C. and x=0.6 (FIG. 6) observed for 95° C. A complete conversion to [DBUH][HCO₃]+imidazole (x=1) was not observed in the tests. [DBUH][HCO₃] is solid at room temperature. The presence of imidazole appears to act as a eutectic mixture, further lowering the melting point and viscosity and this allows the composition stay in liquid phase.

This is believed to be the first identification of the formation of bicarbonate complex in superbase derived protic ionic liquids such as [DBUH][Im] and the first use of excess molar equivalents of water to promote the capture of CO₂ via the formation of bicarbonate.

The desorption data shown in Example 3 above, demonstrate that the amount of CO₂ desorbed after dry [DBUH][Im] ionic liquid/CO₂ complex corresponds to the amount of the CO₂ adsorbed. However, the amount of CO₂ desorbed upon heating the 1:1:1 complex of [DBUH] cation, neutral imidazole molecule, and bicarbonate anion composition to 160° C. corresponds to one half of the CO₂ absorbed. That was because another stable 2:2:1 complex of [DBUH] cation, imidazole molecule, and carbonate anion composition is forming. This is another unique homogeneous composition that has not been made before, and is discussed further below.

### Example 7: Novel Ionic Composition after CO₂ Desorption

The desorption data shown in Example 3, show that the amount of CO₂ desorbed from dry [DBUH][Im] corresponds to the amount of the CO₂ absorbed. This demonstrates that this reaction is fully reversible upon heating to 160° C.

However, when water is present, the amount of CO₂ desorbed upon heating the 1:1 molar composition of [DBUH][HCO₃] and neutral imidazole molecule to 160° C. corresponds to about one half of the absorbed CO₂. That was because another stable 2:2:1 complex of [DBUH] cation, imidazole, and carbonate [CO₃]²⁻ anion composition is forming upon CO₂ desorption. See FIG. 8. During desorption, 2 moles of bicarbonate, [HCO₃]⁻ is dissociated to release 1 mole of CO₂ and 1 mole of water, and then form carbonate [CO₃]²⁻ anion. With this change, a new ionic liquid composition containing 2:1 molar ratio of [DBUH]⁺ cation and [CO₃]²⁻ anion, [DBUH]₂[CO₃], and 2 moles of neutral imidazole is created. This is another unique homogeneous composition that has not been made before.

Until the full CO₂ desorption takes place to reach 1:2 molar complex of [DBUH]₂[CO₃], and neutral imidazole, the composition of IL will have varying compositions of [DBUH][HCO₃]_{1-2y}[CO₃]_{y} and 2y mole of neutral imidazole molecule, where 2y varies from 0.1 to 1. The 2y of 0.1 corresponds 0.1 mole fraction of [DBUH][HCO₃] is converted to 0.05 mole fraction of [DBUH]₂[CO₃] and 0.05 moles of CO₂ and water are released from the ionic liquid.

The results show that a uniform stable composition is made of [DBUH][HCO₃] and neutral imidazole upon absorption by complexation of [DBUH][Im] IL, CO₂ and moisture in 1:1:1 ratio. Upon regeneration, the composition changes to another uniform stable composition of [DBUH]₂[CO₃] and neutral imidazole. These complexes can undergo repeated adsorption and desorption cycles. See FIG. 9. Based on these findings, a reversible CO₂ capture process can be practiced as shown in FIG. 3.

### Example 8

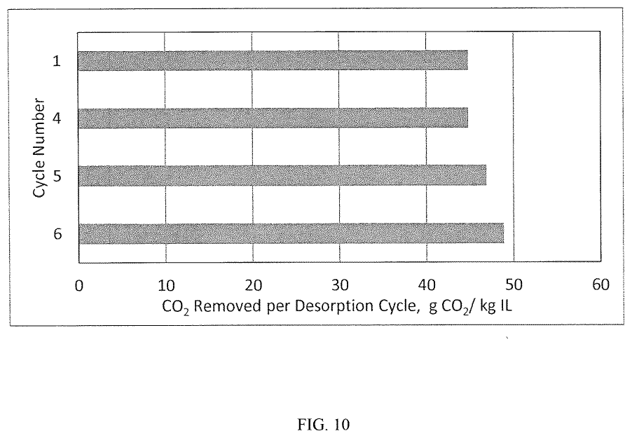

The high temperature CO₂ absorption-desorption cycle was repeated 6 times to examine the impact of repeated cycles on the CO₂ uptake capacity of the ionic liquid. The amount of CO₂ released during desorption can be measured by titration. The released gas was bubbled through a solution of sodium hydroxide which absorbs the CO₂ as bicarbonate and reduces the pH of the solution. By measuring the drop in pH the amount of CO₂ can be calculated. An absorption temperature of 95° C. was selected with a desorption temperature of 160° C. The net CO₂ uptake capacity for each absorption and desorption cycle was determined. The results are plotted in FIG. 10. These results show that water-containing [DBUH][Im] ionic liquid is stable and the CO₂ uptake capacity is well maintained. This ionic liquid can be used in extensive multi-cycle operation and can remove 45-50 g of CO₂ per kg of ionic liquid per absorption and desorption cycle.

Thus, the present process provides one with an energy-efficient post-combustion CO₂ capturing process utilizing protic ionic liquids made of an organic superbase and an organic molecule with a weakly acidic proton. While the concept was demonstrated with an ionic liquid, 1,8-diazabiclclo(5.4.0)undec-7-enium imidazolate, [DBUH][Im], this can be extended to other protic ionic liquid pairs of an organic superbase and an organic molecule with a weakly acidic proton.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

What is claimed is:

1. A process for removal of CO₂ from a flue gas stream containing water vapor and CO₂, the process comprising
(a) contacting the flue gas stream with an ionic absorbent under absorption conditions to absorb at least a portion of the CO₂ from the flue gas stream and form a CO₂-absorbent complex; wherein the ionic absorbent comprises a protic ionic liquid of an organic superbase and a weak acid;
(b) recovering a gaseous flue gas product stream having a reduced CO₂ content.

2. The process of claim 1, wherein the flue gas is a stack gas.

3. The process of claim 1, wherein the flue gas comprises fully saturated water.

4. The process of claim 1, wherein the organic superbase comprises one of the following organic superbases

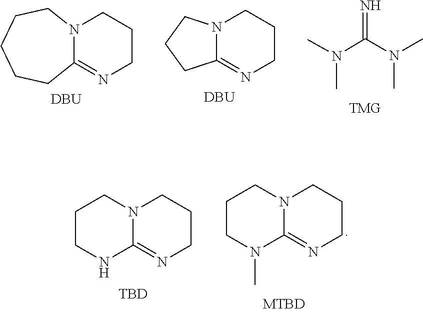

5. The process of claim 1, wherein the weak acid comprises one of the following organic molecules

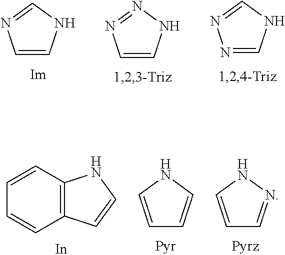

6. The process of claim 1, wherein the ionic absorbent comprises [DBUH][Im] as the protic ionic liquid.

7. The process of claim 1, wherein absorption occurs at a temperature of from 80° C. to 95° C.

8. The process of claim 1, wherein the flue gas stream further contains oxygen compounds, sulfur compounds and nitrogen compounds and the process further comprises removing one or more of COS, NO_{X}, and SO_{X}.

9. The process of claim 1, wherein water-containing ionic absorbent has a viscosity of about 1.8 to 10 cSt.

10. The process of claim 1, wherein water-containing ionic absorbent has a viscosity of less than 30 cSt after absorption of CO₂.

11. The process of claim 1, further comprising subjecting at least a portion of the CO₂− absorbent complex to desorption conditions to form a CO₂ effluent and a stream comprising recovered absorbent.

12. The process of claim 11, wherein the desorption conditions include a temperature of about 160° C. to about 200° C.

13. The process of claim 12, wherein absorption occurs at a temperature of 80° C. to 95° C.

14. The process of claim 7, wherein the desorption occurs at a temperature of 120° C. to 200° C.

15. The process of claim 14, wherein the desorption occurs at a temperature of 140° C. to 200° C.

16. An integrated process where:
a) flue gas is contacted with an IL absorbent comprising a protic ionic liquid of an organic superbase and a weak acid in an absorption unit at a temperature in the range of 80° C. to 95° C.;
b) recovering a gaseous product having a reduced CO₂ content and a CO₂ rich absorbent;
c) passing the CO₂ rich IL absorbent to a regeneration unit where the CO₂ rich IL absorbent is heated to a temperature of at least 120° C.;
d) recovering a CO₂ lean IL absorbent from the regeneration unit and recycling the CO₂ lean IL absorbent to the absorption unit.

17. The process of claim 16, wherein the temperature in the absorption unit is about 95° C.

18. The process of claim 16, wherein the temperature in the regeneration unit is in the range of 120° C. to 200° C.

19. The process of claim 16, wherein the temperature in the regeneration unit is about 160° C.

20. The process of claim 16, wherein the flue gas is a stack gas.

21. The process of claim 16, wherein the flue gas comprises fully saturated water.

22. The process of claim 16, wherein the organic superbase comprises one of the following organic superbases

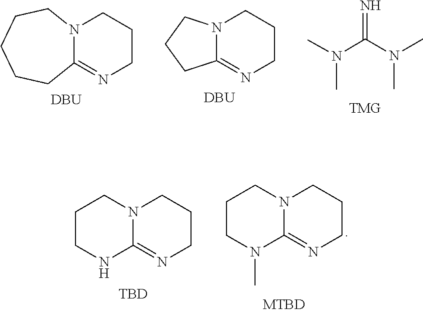

23. The process of claim 16, wherein the weak acid comprises one of the following organic molecules

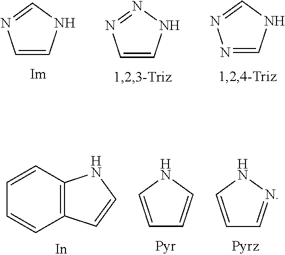

24. The process of claim 16, wherein the ionic absorbent comprises [DBUH][Im] as the protic ionic liquid.

25. A novel composition comprising an organic superbase cation, a bicarbonate anion, and a neutral weak acid.

26. The composition of claim 25, wherein the organic superbase cation is based on one of the following organic superbases:

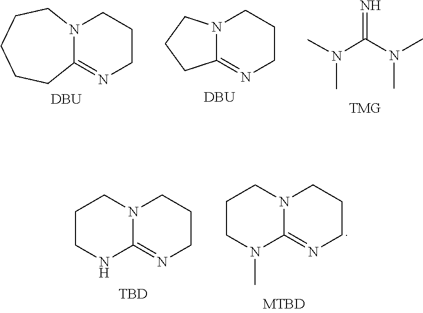

27. The composition of claim 25, wherein the neutral weak acid is based on one of the following organic molecules:

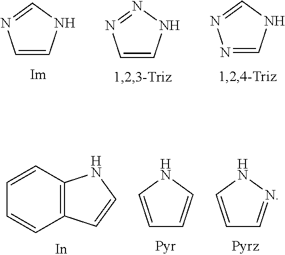

28. The composition of claim 25, wherein the organic superbase cation, bicarbonate anion, and neutral weak acid is in a 1:1:1 molar ratio.

29. The composition of claim 25, wherein the composition comprises [DBUH] cation, neutral imidazole molecule and bicarbonate anion in a 1:1:1 molar ratio.

30. A novel composition comprising an organic superbase cation, a carbonate anion, and a neutral weak acid.

31. The composition of claim 30, wherein the organic superbase cation is based on one of the following organic superbases:

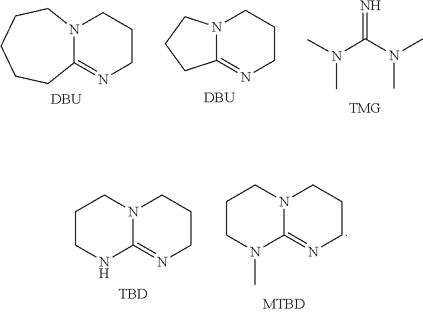

32. The composition of claim 30, wherein the neutral weak acid is based on one of the following molecules:

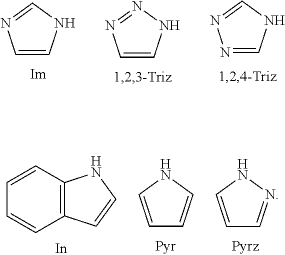

33. The composition of claim 30, wherein the organic superbase cation, neutral week acid and carbonate anion, is in a 2:2:1 molar ratio.

34. The composition of claim 30, wherein the composition comprises [DBUH] cation, neutral imidazole molecule and carbonate anion in a 2:2:1 molar ratio.
